(19) United States
(12) Patent Application Publication
(10) Pub. No.: US 2018/0178316 A1
(43) Pub. Date: Jun. 28, 2018

(54) FRICTION BIT JOINING METHOD OF DIFFERENT MATERIALS

(71) Applicant: Hyundai Motor Company, Seoul (KR)

(72) Inventors: Hoon Mo PARK, Seongnam-si (KR); Dong Hoon NAM, Suwon-si (KR); Jun Ho JANG, Yongin-si (KR); Hoo Dam LEE, Anyang-si (KR); Kyung Moon LEE, Uiwang-si (KR)

(73) Assignee: Hyundai Motor Company, Seoul (KR)

(21) Appl. No.: 15/494,252

(22) Filed: Apr. 21, 2017

(30) Foreign Application Priority Data
Dec. 22, 2016 (KR) 10-2016-0177092

(51) Int. Cl. B23K 20/12; B29C 65/06; B29C 65/00

(52) U.S. Cl. CPC B23K 20/129; B23K 20/1255; B23K 2203/18; B29C 66/74283; B29C 65/0672

(57) ABSTRACT

Disclosed is a method of joining different materials including a polymer composite and high-tensile steel, at excellent joining strength and, more particularly, a method in which various variables in friction bit joining are designed and adjusted to improve joining load between different materials.

### CROSS-REFERENCE(S) TO RELATED APPLICATIONS

The present application claims priority to Korean Patent Application No. 10-2016-0177092 filed on Dec. 22, 2016, the entire contents of which are incorporated herein for all purposes by this reference.

### BACKGROUND OF THE INVENTION

### Field of the Invention

The present invention relates to a method of joining different materials, such as a polymer composite and high-tensile steel, with excellent joining strength. More particularly, it relates to a method in which various variables in friction bit joining are designed and adjusted to improve joining load between different materials.

### Description of Related Art

In the automobile industry, to improve fuel efficiency and address environmental problems, weight reduction of vehicle bodies has been promoted through use of lightweight metals, such as aluminum alloys and plastics. For the present purpose, a joining method, which may substitute for spot welding, generally applied to the assembly of a vehicle body, is being considered now.

Conventional methods of joining different materials include mechanical joining methods, such as a method using a self-piercing rivet (SPR), a friction stir welding (FSW) method using frictional heat, etc.

In the SPR method, a rivet is press-fitted into targets to be joined, such as metal plates, by hydraulic pressure or pneumatic pressure without the formation of holes in targets to be joined and is plastically deformed, thereby joining the targets. Recently, the SPR method is frequently employed in the automobile industry. However, as ultra high-tensile steel having high strength and low elongation is used as a vehicle body now, it may be difficult or impossible to sufficiently join ultra high-tensile steel and a polymer composite using the SPR method.

In the FSW method, by rotating a rivet while applying pressure thereto, the rivet passes through an upper plate formed of a light-weight material and is welded to a lower plate formed of a steel material due to frictional heat caused by rotational friction. However, the FSW method does not exhibit sufficient joining force and thus may not be applied when metal and a polymer composite are joined and, to overcome such a problem, when an adhesive is applied between the upper plate and the lower plate, friction may not effectively occur due to the adhesive and, thus, weld strength may be lowered.

Therefore, development of a method of joining ultra high-tensile steel having high strength and low elongation and a polymer composite with sufficient joining strength is required now.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method of joining ultra high-tensile steel having high strength and low elongation and a polymer composite having light weight including carbon fiber reinforced plastic, with excellent joining strength.

Another aspect of the present invention is directed to provide a method of joining different materials which is designed to improve joining strength.

In one aspect, the present invention is directed to providing a friction bit joining method of different materials, wherein an upper plate formed of a polymer composite and a lower plate formed of a high-tensile steel plate or an ultra high-tensile steel plate are joined using a bit including a head part and a shank part, the bit is formed of high-tensile steel having hardness of HRC 25 to HRC 30, and lap shear strength between the upper plate and the lower plate is designed to be 4 kN to 6.5 kN by adjusting a spindle rotation speed, hardness of the bit, a bit plunge depth and a bit plunge speed.

In an exemplary embodiment, the bit may be formed of high-tensile steel including 0.35% by weight to 0.45% by weight of carbon and, more particularly, be formed of AISI 4140 steel.

In another exemplary embodiment, the polymer composite may be carbon fiber reinforced plastic (CFRP) or glass fiber reinforced plastic (GFRP).

In still another exemplary embodiment, when the lower plate is formed of a high-tensile steel plate having tensile strength of 590 MPa, the upper plate and the lower plate may be joined under conditions below,

spindle rotation speed of 2,500 RPM to 3,000 RPM,

bit hardness of HRC 13 to HRC 18,

bit plunge depth of 0.15 inches to 0.18 inches, and

bit plunge speed of 4 ipm (inches per minute) to 5 ipm.

In yet another exemplary embodiment, hardness of the bit may be adjusted by executing heat treatment of the bit at a temperature of 800° C. to 900° C. and then cooling the bit to a temperature of 650° C. to 700° C. at a cooling speed of 10° C./hr to 15° C./hr.

In still yet another exemplary embodiment, when the lower plate is formed of an ultra high-tensile steel plate having tensile strength of 980 MPa, the upper plate and the lower plate may be joined under conditions below,

spindle rotation speed of 2,000 RPM to 2,200 RPM,

bit plunge depth of 0.15 inches to 0.18 inches, and

bit plunge speed of 6 ipm to 7 ipm.

In a further exemplary embodiment, when the lower plate is formed of an ultra high-tensile steel plate having tensile strength of 1,180 MPa, the upper plate and the lower plate may be joined under conditions below,

spindle rotation speed of 2,500 RPM to 3,000 RPM,

bit hardness of HRC 41 to HRC 45,

bit plunge depth of 0.15 inches to 0.18 inches, and

bit plunge speed of 4 ipm to 5 ipm.

In another further exemplary embodiment, hardness of the bit may be adjusted by executing heat treatment of the bit at a temperature of 800° C. to 900° C., quenching the bit and then tempering the bit at a temperature of 250° C. to 300° C. for 10 minutes to 1 hour.

Various aspects and exemplary embodiments of the invention are discussed infra.

The methods and apparatuses of the present invention have other features and advantages which will be apparent from or are set forth in more detail in the accompanying drawings, which are incorporated herein, and the following Detailed Description, which together server to explain certain principles of the present invention.

### BRIEF DESCRIPTION OF THE DRAWINGS

FIG. 1A, FIG. 1B and FIG. 1C are views sequentially illustrating a process of a friction bit joining method;

FIG. 2 is a graph illustrating a result of measurement of lap shear strengths of joined structures of different materials of Example 1 and Comparative Example 1;

FIG. 3 is a graph illustrating a result of measurement of lap shear strengths of joined structures of different materials of Example 2; and

FIG. 4 is a graph illustrating a result of measurement of lap shear strengths of joined structures of different materials of Example 3, Example 4 and Comparative Example 2.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention to the exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In the following description of the present invention, a detailed description of known functions and configurations incorporated herein will be omitted when it may make the subject matter of the present invention rather unclear. In the following description of the embodiments, the term “including” will be interpreted as indicating the presence of other elements, unless stated otherwise, and does not exclude presence of the corresponding elements.

The present invention relates to a method of joining an upper plate formed of a polymer composite and a lower plate formed of a high-tensile steel plate or an ultra high-tensile steel plate using a bit serving as the joining member. In more detail, the present invention relates to a method of joining an upper plate and a lower plate through a friction bit joining method.

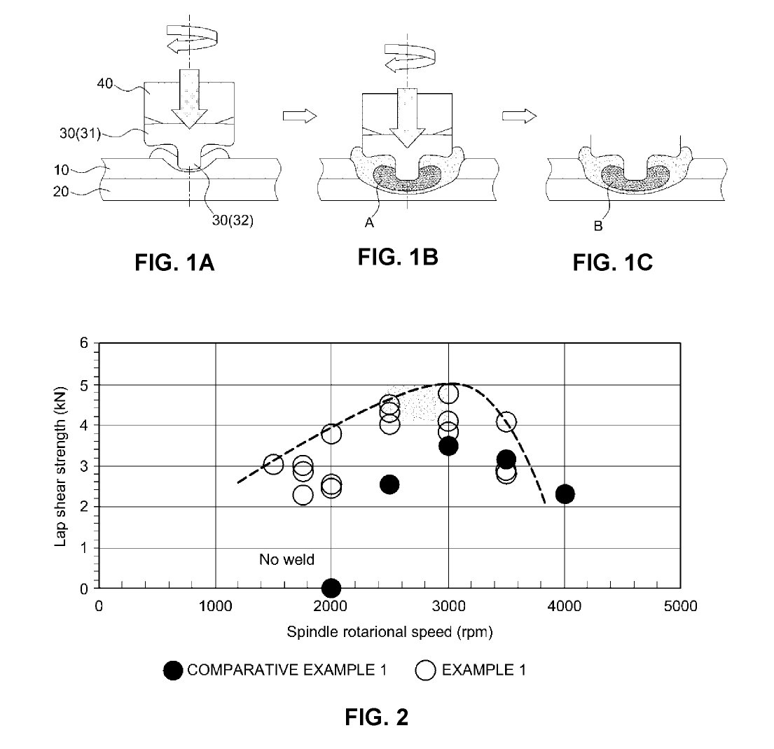

FIG. 1A, FIG. 1B and FIG. 1C are views sequentially illustrating a process of the friction bit joining method. With reference to FIG. 1A, FIG. 1B and FIG. 1C, a bit 30 including a head part 31 and a shank 32 is rotated and pressurized by a tool 40 under the condition that an upper plate 10 and a lower plate 20 are in surface contact with each other, thus penetrating the upper plate 10. Thereafter, the bit 30 is continuously rotated and pressurized by the tool 40 under the condition that the bit 30 contacts the lower plate 20, generating frictional heat between the bit 30 and the lower plate 20. Here, the bit 30 and the periphery thereof are melted by frictional heat (A) and then, when rotation and pressurization of the bit 30 by the tool 40 is stopped, the bit 30 is bonded to the periphery thereof in solid state bonding (B). Through such a process, the upper plate 10 and the lower plate 20 are joined.

In accordance with the present invention, to join the upper plate 10 formed of a polymer composite and the lower plate 20 formed of a high-tensile steel plate or an ultra high-tensile steel plate through the friction bit joining method, frictional heat between the bit 30 and the lower plate 20 should be effectively controlled. The reason for the present is that the polymer composite and the steel plate have different physical properties, i.e., thermal diffusivity and conductivity. When the quantity of frictional heat is insufficient, the state of solid state bonding is poor and joining force is lowered. When the quantity of frictional heat is excessively great, the upper plate formed of the polymer composite is damaged by heat or hardness of the bit is lowered and thus friction between the bit and the lower plate may not occur.

In the present invention, to join a polymer composite and a high-tensile steel plate or an ultra high-tensile steel plate through the friction bit joining method, various variables are adjusted and designed. Hereinafter, this will be described in detail.

The bit 30 may be formed of high-tensile steel having hardness (Rockwell hardness) of HRC 25 to HRC 30, formed of high-tensile steel including 35% by weight to 45% by weight of carbon, and more particularly formed of AISI 4140 steel. Such AISI 4140 steel is a low alloy steel having 0.42% by weight of carbon (C), 0.84% by weight of manganese (Mn) and 0.25% by weight of silicon (Si) and including chromium (Cr), molybdenum (Mo), etc. as strengthening agents.

The bit 30 may include a head part 31 contacting the tool 40 and receiving rotating pressure from the tool 40, and a shank part 32 protruding from the head part 31, as exemplarily shown in FIG. 1. The bit 30 may have other different shapes, as the bit 30 shown in FIG. 1 has a simple shape for process convenience and mass production.

The upper plate 10 may be formed of a polymer composite. In more detail, the upper plate 10 may be formed of carbon fiber reinforced plastic (CFRP) or glass fiber reinforced plastic (GFRP).

As exemplarily shown in FIG. 1, the bit 30 passes through the upper plate 10. As the bit 30 penetrates the upper plate 10, the upper plate 10 may crack and thus chips including burrs, may occur. Such chips may lower the quality of the surface of the upper plate 10 and thus need to be immediately removed. The chips may be removed continuously with or discontinuously from the friction bit joining process. To secure excellent surface quality, the chips may be removed continuously with the friction bit joining process and, although chip removal is not limited to a specific method, a method in which a separate vacuum exhaust structure is formed on a jig or a clamping plate to fix an upper plate and a lower plate and thus inhales chips may be considered.

In a joining method in accordance with an embodiment of the present invention, when the lower plate 20 is formed of a high-tensile steel plate having tensile strength of 590 MPa, the upper plate 10 and the lower plate 20 are joined under conditions below.

Spindle rotation speed of 2,500 RPM to 3,000 RPM

Bit hardness of HRC 13 to HRC 18

Bit plunge depth of 0.15 inches to 0.18 inches

Bit plunge speed of 4 ipm (inches per minute) to 5 ipm

The spindle rotation speed means a rotation speed of the tool 40 about a spindle of the tool 40 and the bit 30.

The bit plunge depth means a depth that the bit 30 penetrates into the lower plate 20 when the bit 30 is continuously rotated by pressure applied by the tool 40 after the bit 30 passes through the upper plate 10 and contacts the lower plate 20.

The bit plunge speed means a speed at which the bit 30 is inserted into the upper plate 10 and the lower plate 20 by the tool 40.

When the above-described conditions are satisfied, the upper plate 10 and the lower plate 20 formed of different materials may be joined with excellent joining strength. In more detail, sufficient frictional heat between the bit 30 and the lower plate 20 formed of the high-tensile steel plate may occur and a joining part may be firmly formed without softening of the bit 30 or damage to the upper plate 10 and lower plate 20 until joining has been completed, when the spindle rotation speed and hardness of the bit 30 are properly adjusted. Further, when the bit plunge depth and plunge speed are properly adjusted, the bit 30 may penetrate the upper plate 10 without deformation of the shape and length of the bit 30.

Hardness of the bit 30 is an important factor to generate friction between the bit 30 and the lower plate 20 and may be adjusted to be similar to hardness of the lower plate 20 by executing specific treatments of the bit 30.

In accordance with the present invention, the bit 30 is formed of high-tensile steel having hardness of HRC 25 to HRC 30 and, in accordance with this embodiment of the present invention in which a high-tensile steel plate (HRC 11.0 to HRC 15.7) having tensile strength of 590 MPa is used as the lower plate 20, hardness of the bit 30 is higher than hardness of the lower plate 20. Therefore, when hardness of the bit 30 is not adjusted, the bit 30 may penetrate the lower plate 20 before sufficient frictional heat occurs.

In the present invention, by adjusting hardness of the bit 30 to be similar to hardness of the lower plate 20, frictional heat between the bit 30 and the lower plate 20 is maximally increased and, in the present case, spindle rotation speed, etc. is adjusted also so that the bit 30 or the upper or lower plate 10 or 20 respectively are not damaged and, thus, joining strength between the polymer composite and the different materials of the high-tensile steel is maximally improved.

In accordance with this embodiment of the present invention, to adjust hardness of the bit 30, heat treatment of the bit 30 is executed at a temperature of 800° C. to 900° C. and then the bit 30 is tempered to a temperature of 650° C. to 700° C. at a cooling speed of 10° C./hr to 15° C./hr. That is, the bit 30 is softened to have hardness of HRC 13 to HRC 18 through the above-described method.

In a joining method in accordance with another embodiment of the present invention, when the lower plate 20 is formed of an ultra high-tensile steel plate having tensile strength of 980 MPa, the upper plate 10 and the lower plate 20 are joined under conditions below.

Spindle rotation speed of 2,000 RPM to 2,200 RPM

Bit plunge depth of 0.15 inches to 0.18 inches

Bit plunge speed of 6 ipm to 7 ipm

The spindle rotation speed, the bit plunge depth and the bit plunge speed have substantially the same meanings as in the above-described earlier embodiment of the present invention and a detailed description thereof will thus be omitted.

In accordance with this embodiment of the present invention, an ultra-high-tensile steel plate having tensile strength of 980 MPa is used as the lower plate 20, and hardness of the lower plate 20 (HRC 30) is similar to that of the bit 30. Therefore, in accordance with this embodiment of the present invention, even when no specific treatment of the bit 30 is executed, sufficient frictional heat between the bit 30 and the lower plate 20 may occur.

In a joining method in accordance with yet another embodiment of the present invention, when the lower plate 20 is formed of an ultra high-tensile steel plate having tensile strength of 1,180 MPa, the upper plate 10 and the lower plate 20 are joined under conditions below.

Spindle rotation speed of 2,500 RPM to 3,000 RPM

Bit hardness of HRC 41 to HRC 45

Bit plunge depth of 0.15 inches to 0.18 inches

Bit plunge speed of 4 ipm to 5 ipm

As described above, the bit 30 is formed of high-tensile steel having hardness of HRC 25 to HRC 30 and, in accordance with this embodiment of the present invention in which an ultra high-tensile steel plate (HRC 42) having a tensile strength of 1,180 MPa is used as the lower plate 20, hardness of the bit 30 is lower than the hardness of the lower plate 20. Therefore, when hardness of the bit 30 is not adjusted, the shape of the bit 30 is deformed and, thus, a joining shape is not uniform, even when sufficient frictional heat occurs, and improvement in joining strength may be insignificant.

Therefore, in accordance with this embodiment of the present invention, to adjust hardness of the bit 30, after heat treatment of the bit 30 is executed at a temperature of 800° C. to 900° C., quenching of the bit 30 is executed and then tempering of the bit 30 is executed at a temperature of 250° C. to 300° C. for 10 minutes to 1 hour. That is, the bit 30 is hardened to have hardness of HRC 41 to HRC 45 through the above-described method.

Consequently, in accordance with the present invention, when the upper plate 10 formed of the polymer composite and the lower plate 20 formed of the high-tensile steel plate or the ultra high-tensile steel plate are joined using the bit 30, the material of the bit 30, the spindle rotation speed, the bit hardness, the bit plunge depth and the bit plunge speed are adjusted so that the upper plate 10 and the lower plate 20 may be joined with sufficient joining strength of 4 kN to 6.5 kN.

Hereinafter, the present invention will be described in more detail through Examples. However, the Examples serve to exemplarily describe the present invention and the scope of the present invention is not limited.

### Example 1 and Comparative Example 1

Different materials are joined through the method shown in FIG. 1 under conditions described below.

A carbon fiber reinforced plastic (CPF3327/M.012 of TB Carbon Co. or K51 of Skyflex Co.) plate having a thickness of 2.0 mm is used as an upper plate and a high-tensile steel plate having a thickness of 1.2 mm and tensile strength of 590 MPa is used as a lower plate.

A bit formed of AIAS 4140 steel and including a head part and a shank part is manufactured and then used. Heat treatment of the bit is executed in a furnace at a temperature of 815° C. and then air-cooling of the bit is executed to a temperature of 665° C. at a cooling speed of 11° C./hr. The completed bit 30 has hardness of HRC 18.

A bit plunge depth is set to 0.17 inches, a bit plunge speed is set to 4 ipm and the upper plate and the lower plate are joined several times using the bit by changing a spindle rotation speed from 1,500 RPM to 4,000 RPM, producing different material joined structures between the polymer composite and the high-tensile steel plate. These conditions are set as Example 1.

For comparison with Example 1, the upper plate and the lower plate are joined under the same conditions as in Example 1 using a bit, the hardness of which is not adjusted, and these conditions are set as Comparative Example 1.

Lap shear strengths of the different material joined structures produced in accordance with Example 1 and Comparative Example 1 are measured and thus joining strengths thereof are evaluated. In more detail, lap shear strengths of the different material joined structures are measured at a deformation speed of 0.4 mm/min using a hydraulic tensile tester (of MTS Co). An acquired result is shown in FIG. 2.

With reference to FIG. 2, it may be understood that the different material joined structures of Example 1, in which hardness of the bit is adjusted, have remarkably higher lap shear strengths than those of the different material joined structures of Comparative Example 1 and, particularly, the different material joined structures of Example 1 have maximal lap shear strength of 4.8 kN to 5.0 kN at a spindle rotation speed of 2,500 RPM to 3,000 RPM.

### Example 2

Different materials are joined through the method shown in FIG. 1 under conditions described below.

A carbon fiber reinforced plastic (CPF3327/M.012 of TB Carbon Co.) plate having a thickness of 2.0 mm is used as an upper plate and an ultra high-tensile steel plate having a thickness of 1.2 mm and tensile strength of 980 MPa is used as a lower plate.

The same bit as the bit used in Example 1 is used. The bit has hardness of HRC 30.

A bit plunge depth is set to 0.17 inches, a bit plunge speed is set to 6.75 ipm, the upper plate and the lower plate are joined several times using the bit by changing a spindle rotation speed from 1,500 RPM to 2,500 RPM, producing different material joined structures between the polymer composite and the high-tensile steel plate. These conditions are set as Example 2.

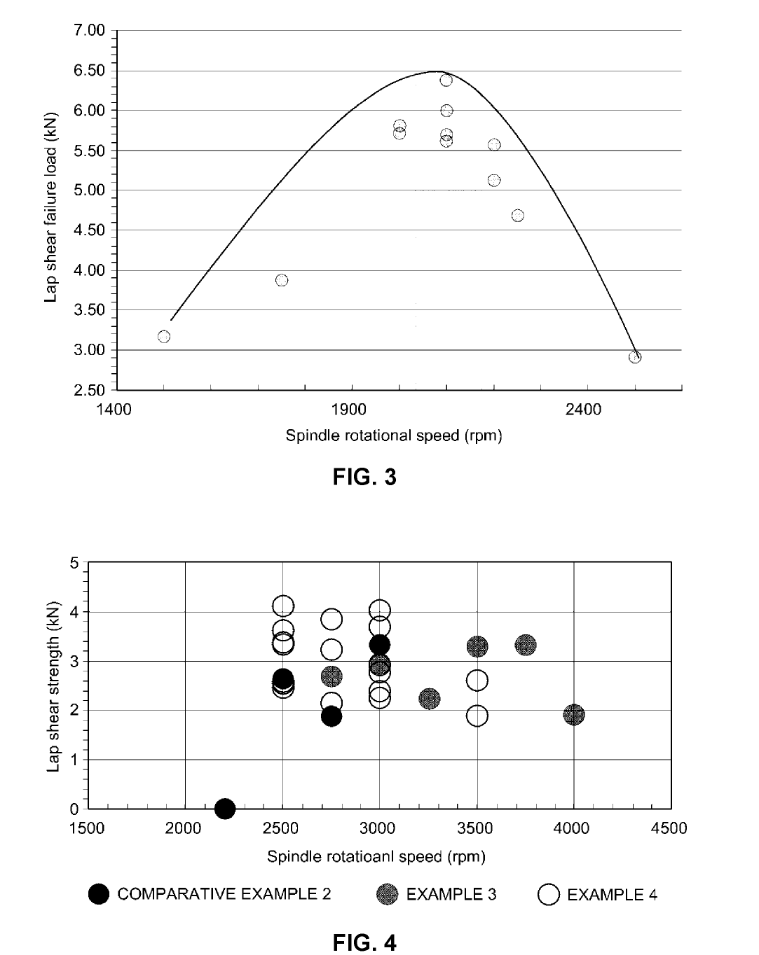

Lap shear strengths of the different material joined structures produced in accordance with Example 2 are measured and thus joining strengths thereof are evaluated. An acquired result is shown in FIG. 3. With reference to FIG. 3, it may be understood that, when the spindle rotation speed is less than 2,000 RPM, frictional heat is insufficient and thus lap shear strength is rapidly lowered and, when the spindle rotation speed exceeds 2,200 RPM, the quantity of frictional heat is excessively large and, thus, the upper plate is damaged or the bit is softened and fractured and lap shear strength is rapidly lowered also. Further, it may be understood that, when the hardness of the bit, the bit plunge depth and the bit plunge speed satisfy the above-described conditions and the spindle rotation speed is 2,000 RPM to 2,200 RPM, maximal lap shear strength of up to approximately 6.5 kN is measured.

### Example 3, Example 4 and Comparative Example 2

Different materials are joined through the method shown in FIG. 1 under conditions described below.

A carbon fiber reinforced plastic (CPF3327/M.012 of TB Carbon Co.) plate having a thickness of 2.0 mm is used as an upper plate and an ultra high-tensile steel plate having a thickness of 1.2 mm and tensile strength of 1,180 MPa is used as a lower plate.

The same bit as the bit used in Example 1 is used. After heat treatment of the bit is executed at a temperature of 850° C., oil quenching of the bit is executed, and then tempering of the bit is executed at a temperature of 260° C. for 0.5 hours. The completed bit has hardness of HRC 41 to HRC 45.

A bit plunge depth is set to 0.17 inches, a bit plunge speed is set to 4 ipm and the upper plate and the lower plate are joined several times using the bit by changing a spindle rotation speed from 2,200 RPM to 4,000 RPM, producing different material joined structures between the polymer composite and the high-tensile steel plate. These conditions are set as Example 3. Further, the upper plate and the lower plate are joined several times using the bit through the same method as Example 3, except that the bit plunge speed is set to 5 ipm and the spindle rotation speed is changed from 2,500 RPM to 3,500 RPM, producing different material joined structures between the polymer composite and the high-tensile steel plate. These conditions are set as Example 4.

For comparison with Example 3 and Example 4, the upper plate and the lower plate are joined under the same conditions as in Example 4 using a bit, the hardness of which is not adjusted, and these conditions are set as Comparative Example 2.

Lap shear strengths of the different material joined structures produced in accordance with Example 3, Example 4 and Comparative Example 2 are measured and thus joining strengths thereof are evaluated. An acquired result is shown in FIG. 4.

With reference to FIG. 4, it may be understood that the different material joined structures produced in accordance with Example 3 and Example 4, in which hardness of the bit is adjusted, have higher lap shear strengths than those of the different material joined structures produced in accordance with Comparative Example 2 and, The different material joined structures of Example 4 have maximal lap shear strength of about 4.2 kN at a spindle rotation speed of 2,500 RPM to 3,000 RPM.

Although Example 1 to Example 4 use the high-tensile steel plate having tensile strength of 590 MPa or the ultra high-tensile steel plate having tensile strength of 980 MPa or 1,180 MPa as a lower plate, the present invention is not limited thereto and other high-tensile steel plates or ultra high-tensile steel plates may be used as a lower plate to join an upper plate and the lower plate at excellent joining strength, when a spindle rotation speed, hardness of a bit, bit plunge depth and bit plunge speed are properly designed and adjusted.

As is apparent from the above description, a friction bit joining method of different materials in accordance with the present invention may have effects, as below.

When ultra high-tensile steel and a polymer composite are joined, a spindle rotation speed, hardness of a bit, etc. may be properly designed and thus, different materials may be joined with excellent joining strength without damage to a joining part and surface defects.

Therefore, the friction bit joining method of different materials in accordance with the present invention may provide a different materials joined structure having greatly improved energy absorption capacity, light-weight efficiency and durability can be provided.

Further, by applying a design method and design factors in accordance with the present invention, even when any high-tensile steel or any ultra high-tensile steel is used, the high-tensile steel or the ultra high-tensile steel may be joined with a polymer composite having light weight with excellent joining strength.

For convenience in explanation and accurate definition in the appended claims, the terms “upper”, “lower”, “internal”, “outer”, “up”, “down”, “upwards”, “downwards”, “front”, “back”, “rear”, “inside”, “outside”, “inwardly”, “outwardly”, “internal”, “external”, “forwards” and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A friction bit joining method of different materials, wherein an upper plate formed of a polymer composite and a lower plate formed of a high-tensile steel plate or an ultra high-tensile steel plate are joined using a bit including a head part and a shank part;
the bit is formed of high-tensile steel having hardness of HRC 25 to HRC 30; and
lap shear strength between the upper plate and the lower plate is designed to be 4 kN to 6.5 kN by adjusting a spindle rotation speed, hardness of the bit, a bit plunge depth and a bit plunge speed.

2. The friction bit joining method of the different materials of claim 1, wherein the bit is formed of high-tensile steel including 0.35% by weight to 0.45% by weight of carbon.

3. The friction bit joining method of the different materials of claim 1, wherein the bit is formed of AISI 4140 steel.

4. The friction bit joining method of the different materials of claim 1, wherein the polymer composite is carbon fiber reinforced plastic (CFRP) or glass fiber reinforced plastic (GFRP).

5. The friction bit joining method of the different materials of claim 1, wherein, when the lower plate is formed of a high-tensile steel plate having tensile strength of 590 MPa, the upper plate and the lower plate are joined under conditions of spindle rotation speed of 2,500 RPM to 3,000 RPM, bit hardness of HRC 13 to HRC 18, bit plunge depth of 0.15 inches to 0.18 inches, and bit plunge speed of 4 ipm (inches per minute) to 5 ipm.

6. The friction bit joining method of the different materials of claim 5, wherein hardness of the bit is adjusted by executing heat treatment of the bit at a temperature of 800° C. to 900° C. and then cooling the bit to a temperature of 650° C. to 700° C. at a cooling speed of 10° C./hr to 15° C./hr.

7. The friction bit joining method of the different materials of claim 1, wherein, when the lower plate is formed of an ultra high-tensile steel plate having tensile strength of 980 MPa, the upper plate and the lower plate are joined under conditions of spindle rotation speed of 2,000 RPM to 2,200 RPM, bit plunge depth of 0.15 inches to 0.18 inches, and bit plunge speed of 6 ipm to 7 ipm.

8. The friction bit joining method of the different materials of claim 1, wherein, when the lower plate is formed of an ultra high-tensile steel plate having tensile strength of 1,180 MPa, the upper plate and the lower plate are joined under conditions of spindle rotation speed of 2,500 RPM to 3,000 RPM, bit hardness of HRC 41 to HRC 45, bit plunge depth of 0.15 inches to 0.18 inches, and bit plunge speed of 4 ipm to 5 ipm.

9. The friction bit joining method of the different materials of claim 8, wherein hardness of the bit is adjusted by executing heat treatment of the bit at a temperature of 800° C. to 900° C., quenching the bit and then tempering the bit at a temperature of 250° C. to 300° C. for 10 minutes to 1 hour.
